(19) United States
(12) Patent Application Publication
(10) Pub. No.: US 2024/0298285 A1
(43) Pub. Date: Sep. 5, 2024

(54) METHOD AND APPARATUS FOR HANDLING REGISTRATION OF USER EQUIPMENT TO NETWORK SLICE

(71) Applicant: SAMSUNG ELECTRONICS CO., LTD., Suwon-si, Gyeonggi-do (KR)

(72) Inventors: Varini GUPTA, Bangalore (IN); Lalith KUMAR, Bangalore (IN); Ashok Kumar NAYAK, Bangalore (IN)

(21) Appl. No.: 18/574,679

(22) PCT Filed: Jun. 24, 2022
(86) PCT No.: PCT/KR2022/009086

§ 371 Date: Dec. 27, 2023

(30) Foreign Application Priority Data
Jun. 29, 2021 (IN) 202141028987
Jun. 16, 2022 (IN) 202141028987

(51) Int. Cl. H04W 60/00

(52) U.S. Cl. CPC H04W 60/00

(57) ABSTRACT

The disclosure relates to a 5G or 6G communication system for supporting a higher data transmission rate. A method for handling registration of a UE by a network apparatus, includes determining a list of NSSAI to which the UE connects to receive at least one service an indication for each single NSSAI(S-NSSAI) in the list of configured NSSAI to indicate whether the UE needs to attempt to connect to that S-NSSAI upon receiving the list of configured NSSAI, and transmitting a message including the list of configured NSSAI and the indication to the UE.

### TECHNICAL FIELD

The present disclosure generally relates to requesting Single Network Slice Selection Assistance Information (S-NSSAI) in a wireless communication network. Particularly, but not exclusively, the present disclosure relates to methods and systems for optimizing registration of a User Equipment (UE) to one or more network slices and/or one or more data networks.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The 5G network facilitates diversified services such as mobile voice and text communication, industrial Internet of Things (IoT), smart home domestic IoT, low latency medical communication, high bandwidth mobile broadband etc. Each of these services require different data behaviour and Quality of Service (QOS) from network infrastructure.

In order to meet such requirement, Third Generation Partnership Project (3GPP) in Release-15 has introduced network slicing technology, in which network service providers compartmentalise a network into various network slices according to type of service. More specifically, each of the network slices corresponds to a logical network connection unit for data transfer so that a User Equipment (UE) can connect to one or more of the network slices based on the services the UE has subscribed to. Each of the network slices is uniquely identified by a Single Network Slice Selection Information (S-NSSAI), which comprises a slice/service type (SST) that refers to an expected network slice behaviour in terms of features and services, and a slice differentiator (SD) that is optional information and complements the SST(s) to differentiate amongst multiple network slices of the same SST.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Technical Problem

The principal object of the embodiments herein is to disclose a method and system for optimizing registration of a UE to one or more network slices and/or one or more data networks.

The embodiments of the present disclosure may be used to enable the UE to distinguish one or more essential S-NSSAIs from a list of S-NSSAIs present in a configured NSSAI list, so that the UE can always include the one or more essential S-NSSAIs in the requested NSSAI during registration procedure.

Due to this, the UE remains connected to such S-NSSAIs while ensuring improves utilization of the network resources. Consequently, network performance is enhanced and overall 5G experience of the user is improved.

### Solution to Problem

Accordingly, the embodiments herein provide methods for handling registration of a UE to a network apparatus. The method includes determining, by the network apparatus, at least one policy comprising at least one of a list of S-NSSAI and a list of DNN to which the UE connects to receive at least one service provided by the network apparatus. Further, the method includes transmitting, by the network apparatus, the at least one policy to the UE for providing the at least one service.

In an embodiment, the at least one policy is transmitted to the UE over a message, wherein the message comprises at least one of a registration accept message, a UE configuration update message and a Non-access stratum (NAS) message.

In an embodiment, the at least one policy transmitted to the UE comprises the list of S-NSSAIs, wherein, for cach S-NSSAI in the list of S-NSSAIs, an indication is provided to indicate if the UE needs to attempt to connect to that the S-NSSAI at every opportunity by including in requested-NSSAI during a registration procedure.

In an embodiment, the at least one policy transmitted to the UE comprises the list of S-NSSAIs, wherein the list of S-NSSAIs is taken from a Configured-NSSAI.

In an embodiment, at least one of a Configured-NSSAI and an Allowed-NSSAI information element (IE) is extended to indicate, for each constituent S-NSSAI, whether the UE needs to attempt to connect to that S-NSSAI at every opportunity.

In an embodiment, the network apparatus transmits a default configured-NSSAI IE, wherein the default configured-NSSAI IE is extended to indicate, for each constituent S-NSSAI, whether the UE needs to attempt to connect to that S-NSSAI at every opportunity.

In an embodiment, the at least one policy transmitted to the UE comprises a list of DNNs, wherein for cach DNN in the list of DNNs, an indication is provided to indicate if the UE needs to attempt to establish connectivity to that DNN at every opportunity.

In an embodiment, UE Route Selection Policy (URSP) information is extended to indicate, for cach DNN in the URSP, if the UE needs to attempt to establish connectivity to that DNN at every opportunity.

In an embodiment, the method includes determining, by the network apparatus, at least one operating mode of the UE to remain connected to resource of the network apparatus to avail an uninterrupted service among the at least one service from the network apparatus, wherein the operating mode comprises at least one of an always-registered mode and an on-demand mode. Fuhrer, the method includes transmitting, by the network apparatus, the operating mode to the UE using at-least one of a registration-accept, a UE configuration update and a NAS message.

In an embodiment, for the always-registered mode, the UE requests for a network slice by comprising a required S-NSSAI in a requested-NSSAI IE, even if the UE is unable to determine whether at least one of application running in the UE requires use of a required S-NSSAI.

In an embodiment, the always-registered mode, the UE initiates establishment of a protocol data unit (PDU) session to a DNN, even if the UE is unable to determine whether at least one of application running in the UE requires an established PDU session to that DNN to transmit or receive a user data.

In an embodiment, for the on-demand mode, the UE requests for a network slice by including in a requested-NSSAI IE or initiates an establishment of a PDU session to a DNN when the UE confirms if at least one of the application running in the UE requires services of the corresponding S-NSSAI or DNN.

In an embodiment, the method includes receiving, by the network apparatus, at least one of a list of required S-NSSAIs and a required DNN from the UE during at least one of a network registration procedure and a PDU session establishment procedure. Further, the method includes performing, by the network apparatus, at least one of: transmitting the policy to indicate the UE to attempt to remain registered all the time to the required S-NSSAI and other essential S-NSSAIs and the required DNN and other essential DNNs, and transmitting the policy to indicate the UE to attempt to remain registered all the time to all the S-NSSAIs including the essential S-NSSAIs and all the DNNs including essential DNNs.

In an embodiment, the method includes determining, by the network apparatus, that the UE has not included at least one essential S-NSSAIs in a requested-NSSAI Information Element (IE) during a registration request, when a subscription information of the UE indicates that the UE needs to remain registered to the at least one essential S-NSSAIs all the time. Further, the method includes determining, by the network apparatus, current availability of the at least one essential S-NSSAIs. Further, the method includes determining, by the network apparatus, whether the at least one essential S-NSSAIs is allowed to be used in a current registration area of the UE upon determining the availability of the at least one essential S-NSSAIs. Further, the method includes transmitting, by the network apparatus, a registration accept message including a new information clement (IE) indicating availability of additional essential S-NSSAIs upon determining that the at least one essential S-NSSAIs is allowed in the current registration arca.

In an embodiment, the method includes indicating, by the network apparatus, in a registration accept message whether the UE should attempt to remain connected to the S-NSSAI(s) all the time.

In an embodiment, the method includes indicating, by the network apparatus, in a PDU session establishment response message, whether the UE should attempt to remain connected to DNN all the time.

Accordingly, the embodiments herein provide methods for handling registration of a UE to a network apparatus. The method includes receiving, by the UE, a policy comprising at least one of a list of Single Network Slice Selection Information (S-NSSAI) and a list of Data Network Name (DNN) from a network apparatus over a message. The method includes indicating, by the UE, at least one of at least one S-NSSAI from the list of S-NSSAIs and at least one DNN from the list of DNN to the network apparatus for accessing at least one service during at least one of a network registration procedure and a Protocol Data Unit (PDU) session establishment procedure.

In an embodiment, the method includes determining, by the UE, at least one operating mode of the UE to remain connected to resource of the network apparatus to avail an uninterrupted service among the at least one service from the network apparatus, wherein the operating mode comprises at least one of an always-registered mode and an on-demand mode.

In an embodiment, the method includes performing, by the network apparatus, at least one of determining the policy to indicate the UE to attempt to remain registered all the time to the required S-NSSAI and other essential S-NSSAIs and the required DNN and other essential DNN based on the indication; and transmitting the policy to indicate the UE to attempt to remain registered all the time to the all the S-NSSAI including the required S-NSSAI and all the DNN including essential DNN.

Accordingly, the embodiments herein provide a network apparatus includes a registration handling controller coupled with a processor and a memory. The registration handling controller is configured to determine at least one policy comprising at least one of a list of S-NSSAI and a list of DNN to which the UE connects to receive at least one service provided by the network apparatus. Further, the registration handling controller is configured to transmit the at least one policy to the UE for providing the at least one service.

Accordingly, the embodiments herein provide a UE includes a registration handling controller coupled with a processor and a memory. The registration handling controller is configured to receive a policy comprising at least one of a list of S-NSSAI and a list of essential DNN from a network apparatus over a message. Further, the registration handling controller is configured to indicate at least one of at least one S-NSSAI from the list of S-NSSAIs and at least one DNN from the list of essential DNN to the network apparatus during at least one of a network registration procedure and a PDU session establishment procedure.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates exemplary representation of a first type of implementation in a UE for selecting S-NSSAIs in a requested-NSSAI IE utilizing a list of configured NSSAI;

FIG. 2 illustrates exemplary representation of a second type of implementation in a UE for selecting S-NSSAIs in a requested-NSSAI IE based on application requirement;

FIG. 3 illustrates overview of a system for optimizing registration of the UE to a network slice and the network apparatus, according to embodiments as disclosed hercin;

FIG. 4 illustrates various hardware components of the network apparatus, according to embodiments as disclosed herein;

FIG. 5 illustrates various hardware components of the UE, according to embodiments as disclosed herein;

FIG. 6 illustrates exemplary representation in which the UE selects S-NSSAIs in a requested-NSSAI IE based on application requirement, according to embodiments as disclosed herein.

FIG. 7 shows a flow chart illustrating a method, implemented by the network apparatus, for optimizing registration of the UE to a network slice and the network apparatus, according to embodiments as disclosed herein; and

FIG. 8 shows a flow chart illustrating a method, implemented by the UE, for optimizing registration of the UE to the network slice and the network apparatus, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

In a 5G network, a list of network slices allowed to the UE, known as configured-NSSAI list, may be configured in the UE. The configured-NSSAI list may be utilized by the UE for indicating, to the 5G network, the services the UE wishes to consume at any point of time. Further, a list of Data Network Names (DNNs), which includes one or more data networks allowed to the UE, may be configured in the UE, for availing data connectivity to one or more data-networks such as an enterprise or the world-wide-web. Also, the UE may be configured with UE Route Selection Policy (URSP) rules which comprises a set of policies for selecting one or more S-NSSAIs and/or DNNs based on applications used by the UE.

In a 5G environment, under each Public Land Mobile Network (PLMN), the UE may transmit a registration request comprising a requested-NSSAI Information Element (IE) to an access and mobility management function (AMF) entity to register with the 5G network. The requested-NSSAI IE may comprise one or more S-NSSAIs indicating the network slices, the UE wishes to access. In response to the registration request, the UE may receive a registration accept message including allowed NSSAI, which indicates one or more allowed network slices to the UE based on the requested NSSAI, and rejected NSSAI, which indicates one or more rejected network slices not allowed for the UE.

During a registration procedure, the UE may select, based on the configured-NSSAI list, one or more S-NSSAI to be included in the requested-NSSAI IE according to type of implementations. As an example, in a first type of implementation, the UE may select all the S-NSSAIs present in the configured-NSSAI list for including in the requested-NSSAI IE, irrespective of requirements of the UE for accessing the services.

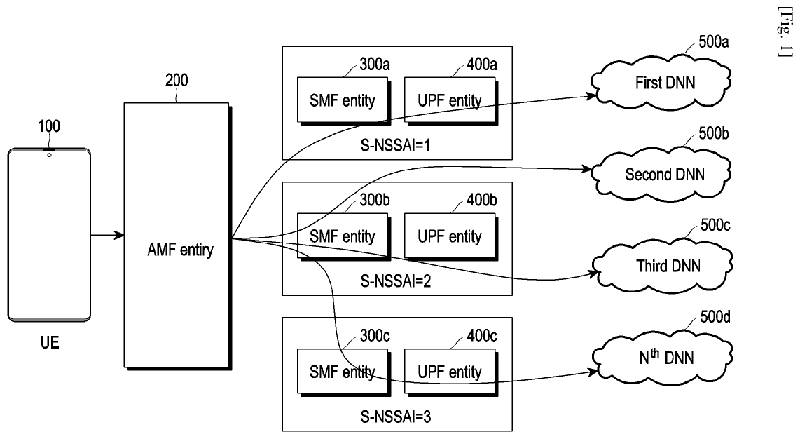

FIG. 1 illustrates exemplary representation of a first type of implementation.

Referring to FIG. 1, a configured-NSSAI list of a UE 100 may include a S-NSSAI 1, a S-NSSAI 2, and a S-NSSAI 3. A AMF entity 200 may provide transport for messages between the UE 100 and at least one of first network apparatus, a second network apparatus, or a third network apparatus. The first network apparatus having the S-NSSAI 1 may include a session management function (SMF) entity 300a and/or an user plane function (UPF) entity 400a, the second network apparatus having the S-NSSAI 2 may include a SMF entity 300b and/or a UPF entity 400b, and the third network apparatus having the S-NSSAI 3 may include a SMF entity 300c and/or a UPF entity 400c. In one embodiment, subscription information for each of the aforesaid S-NSSAIs may have one or more DNNs 500a, 500b, 500c, and 500d, such as the S-NSSAI 1 may have DNN 1 500a configured, the S-NSSAI 2 may have DNN 2 500band DNN 3 500c configured, and the S-NSSAI 3 may have DNN N 500d configured.

In one embodiment, the UE 100 may include S-NSSAI 1, S-NSSAI 2, and S-NSSAI 3 in the requested-NSSAI IE according to the first type of implementation and transmits a registration request to the AMF entity 200 including the requested-NSSAI IE. In response, the network (e.g., the AMF entity 200) may transmit an allowed NSSAI IE including the S-NSSAI 1, the S-NSSAI 2, and the S-NSSAI 3. Consequently, the UE 100 may be registered to all the network slices. Additionally, the UE 100 may register to data networks corresponding to S-NSSAI 1, S-NSSAI 2, and S-NSSAI 3. However, the first type of implementation leads to wasteful utilisation of the network resources, because the UE 100 registers to all the S-NSSAIs even when corresponding services are not required by the UE 100.

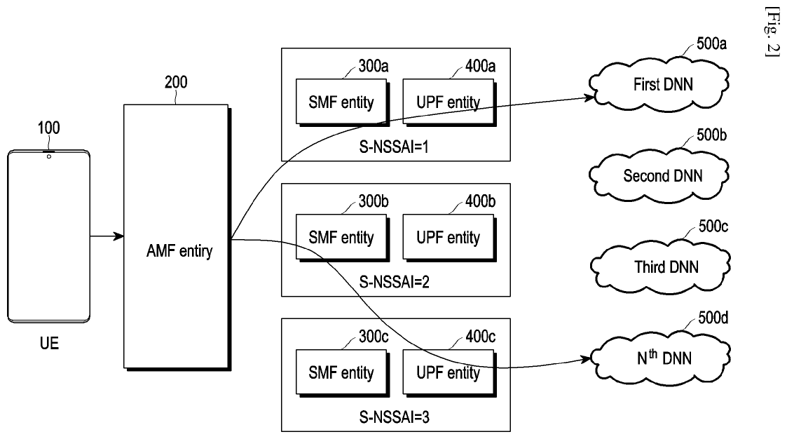

FIG. 2 illustrates exemplary representation of a second type of implementation.

Referring to FIG. 2, the UE 100 may only select specific S-NSSAIs out of the S-NSSAIs present in the configured-NSSAI list, based on current requirement of the UE 100, for including in the requested-NSSAI IE. In one embodiment, the UE 100 may only include S-NSSAI 1, and S-NSSAI 3, which serve applications currently accessed by the UE 100, in the requested-NSSAI IE, and transmit a registration request to the AMF entity 200 including the requested-NSSAI IE. In response, the network (e.g., the AMF entity 200) may transmit an allowed NSSAI IE including the S-NSSAI 1, and the S-NSSAI 3. Consequently, the UE 100 may be registered to only specific network slices and some of the data networks corresponding to S-NSSAI 1, and S-NSSAI 3. The second type of implementation is advantageous in terms of improved utilization of the network resources.

In some scenarios, the UE 100 cannot connect to one or more network slices based on the application requirements because of exhaustion of quota of network resources assigned to the network slices. Moreover, in case of congestion, the network may reject new registrations to the network slices, but allow existing registrations to continue. Further, the network may want UEs to remain connected while the UEs are serving critical applications. In such scenarios, there is high probability that the UE 100 with second type of implementation receives a rejected NSSAI, which includes the S-NSSAIs selected based on the current requirements of the UE 100, in the registration accept message. This leads poor user experience.

Furthermore, during Protocol Data Unit (PDU) Session establishment to DNNs, the UE 100 may activate and keep a PDU session only when there is at-least one application that requires or utilizes the data-path provided by the PDU session. Alternatively, in some scenarios, the UE 100 may activate and deactivate the PDU session based on requirement.

In an example, the UE 100 may have activated the PDU session establishment to the DNN 1 500a and has deactivated the PDU session establishment to the DNN 2 500b. In such scenarios, if the quota of network resources assigned to the network slice is already exhausted and/or if network congestion occurs, the UE 100 may run into issues due to non-availability of the network resources.

Accordingly, the embodiments hercin provide a network apparatus may include a registration handling controller (e.g., the registration handling controller 640) coupled with a processor (e.g., the processor 610) and a memory (e.g., the memory 630). The registration handling controller may be configured to determine at least one policy comprising at least one of a list of S-NSSAI and a list of DNN to which the UE connects to receive at least one service provided by the network apparatus. Further, the registration handling controller may be configured to transmit the at least one policy to the UE for providing the at least one service.

In an embodiment, the present disclosure may provide a method and a system for optimizing registration of a UE to one or more network slices and one or more data networks. Here, a serving network or a home network may determine essential S-NSSAIs and/or essential DNN to which the UE should remain connected in an uninterrupted manner. Further, the network may transmit a list of the determined essential S-NSSAIs and/or the list of the determined essential DNNs to the UE in a new message, or an existing message, in terms of policy or new information element (IE). Further, upon receiving such information, the UE may always indicate the essential S-NSSAIs and/or the essential DNNs to the serving network during network registration procedure or PDU session establishment procedure(s).

In an embodiment, the network may determine one of operating modes of the UE to remain connected to network resources to avail uninterrupted service from the network. The operating mode may include an always-registered mode and an on-demand mode. In the always-registered mode, the UE may request for a network slice by including certain S-NSSAIs in the requested-NSSAI IE, or initiates establishment of a PDU session, even though the UE is unable to determine whether at least one of applications of the UE requires use of the registered network slice or the established PDU session to transmit or receive the user data. In the on-demand mode, the UE may request for the network slice by including in the requested-NSSAI IE or initiates establishment of the PDU session only when the UE is sure if at least one of the applications of the UE require the network resources such as network slices or data networks. The always-registered mode or the on-demand mode may be configured in the UE for registering to at least one of network slices and data networks.

In an embodiment, the system may comprise a Public Land Mobile Network (PLMN) and the UE. The PLMN may include, but not limited to, a serving PLMN, and a home PLMN. The serving PLMN may include, but not limited to an Access and Mobility Management Function (AMF), Network Slice Selection Function (NSSF) and the like. Further, the home PLMN may include Unified Data Management (UDM) functions and the like. In an embodiment, the PLMN may transmit at least one of the Network Slice Registration Policy (NSRP) or a Network Slice Registration Information Element (NSRIE) to the UE. The NSRIE may include a list of essential S-NSSAIs to which the UE must remain registered.

Referring now to the drawings, and more particularly to FIGS. 3 through 8, where similar reference characters denote corresponding features consistently throughout the figures, there are shown at least one embodiment.

FIG. 3 illustrates overview of a system 1000 for optimizing registration of a UE 100 to a network slice and a network apparatus 600, according to embodiments as disclosed hercin.

Referring to FIG. 3, the system 1000 may include the UE 100 and the network apparatus 600. The UE 100 which may be implemented as an electronic device can be, for example, but not limited to a laptop, a desktop computer, a notebook, a Device-to-Device (D2D) device, a vehicle to everything (V2X) device, a smartphone, a foldable phone, a smart TV, a tablet, an immersive device, and an internet of things (IoT) device. The network apparatus 600 can be, for example, but not limited to an AMF entity 200, a SMF entity 300 (e.g., the SMF entity 300a, 300b, or 300c), a UDM entity 700 or the like.

The network apparatus 600 may determine the at least one policy comprising the list of S-NSSAI and/or a list of DNN to which the UE 100 connects to receive the service provided by the network apparatus 600. The network apparatus 600 may transmit the policy to the UE 100 for providing the service. The UE 100 may receive the policy comprising the list of S-NSSAI and/or the list of DNN from the network apparatus 600 over a message. The UE 100 may indicate at least one of at least one S-NSSAI from the list of S-NSSAIs and at least one DNN from the list of DNN to the network apparatus 600 for accessing at least one service during at least one of a network registration procedure and a PDU session establishment procedure respectively.

In an example, the serving PLMN (e.g., the network apparatus 600 of the serving PLMN) may transmit the policy (e.g., NSRP) for each S-NSSAI contained in configured-NSSAI to the UE 100. The serving PLMN may transmit the NSRP to indicate the UE 100 to remain registered all the time to the one or more essential S-NSSAIs. The UE 100 may configure the received NSRP. Upon configuring the NSRP, the UE 100 may be adapted to always include the one or more essential S-NSSAIs in a requested-NSSAI IE while transmitting a registration request to the serving PLMN. Further, the serving network (e.g., the network apparatus 600 of the serving PLMN) may transmit to the UE 100 a registration accept message, always including the one or more essential S-NSSAIs in an allowed NSSAI IE. In an alternative embodiment, the UE 100 may selectively exclude the one or more essential S-NSSAIs from the requested-NSSAI IE in the registration request, upon determining that a current registration area does not support one or more essential S-NSSAIs, or upon receiving the one or more essential S-NSSAIs in a rejected-NSSAI IE from the network.

In another example, the home PLMN (e.g., the network apparatus 600 of the home PLMN) may transmit the NSRP for each constituent S-NSSAI contained in default configured-NSSAI to the UE 100. The home PLMN may transmit the NSRP to indicate the UE 100 to remain registered all the time to the one or more essential S-NSSAIs. The default configured-NSSAI list may be applied to any serving PLMNs for which no specific configured NSSAI has been provided to the UE 100. Further, the UE 100 may configure the received NSRP such that the UE 100 is adapted to always include the one or more essential S-NSSAIs in a requested-NSSAI IE while transmitting a registration request to the home PLMN or the serving PLMN. In response to the registration request, the UE 100 may always receive a registration accept message, always including the one or more essential S-NSSAIs in an allowed NSSAI IE. In an alternative embodiment, the UE 100 may selectively exclude the one or more essential S-NSSAIs from the requested-NSSAI IE in the registration request, upon determining that a current registration area does not support one or more essential S-NSSAIs, or upon receiving the one or more essential S-NSSAIs in a rejected-NSSAI IE from the network.

In another example, upon receiving the registration request from the UE 100, the serving PLMN may determine that the UE 100 has not included the one or more essential S-NSSAIs in the requested-NSSAI Information Element (IE) during transmitting the registration request, even when subscription information of the UE 100 indicates that the UE 100 needs to remain registered to the one or more essential S-NSSAIs all the time. Further, the serving PLMN may determine current availability of the one or more essential S-NSSAIs. Upon determining the availability of the one or more essential S-NSSAIs, the serving PLMN may determine whether the one or more essential S-NSSAIs can be allowed to be used in a current registration area of the UE 100. If it is determined that the one or more essential S-NSSAIs can be allowed in the current registration area, the serving PLMN may transmit a registration accept message including a new IE indicating availability of additional essential S-NSSAIs. Upon receiving the registration accept message, the UE 100 may initiate registration to the additional essential S-NSSAIs. Here, the UE 100 may transmit then transmit another registration request to the serving PLMN including the additional essential S-NSSAIs in the requested-NSSAI IE. In an alternative embodiment, the serving PLMN may include the additional essential S-NSSAIs in an allowed-NSSAI IE in the registration accept message, even if the additional essential S-NSSAIs were not included in the requested-NSSAI IE by the UE 100 while sending Registration request. Alternatively, the serving PLMN may always include respective network slices in the allowed-NSSAI IE during transmitting the registration accept message.

In another embodiment, when network sends Registration Accept message to the UE 100, the registration accept message may include an indication, for each S-NSSAI contained in Allowed-NSSAI, whether UE 100 should remain connected to this S-NSSAI all the time, and not initiate disconnection even when no application is using it. Thus, the UE 100 may become able to remain connected the essential S-NSSAIs all the time, even when none of the applications of the UE 100 is using the essential S-NSSAIs.

In an example, a network (e.g., the network apparatus 600) may transmit a PDU session establishment accept message to the UE 100, directing the UE 100 to remain connected to one or more essential DNNs all the time, and not initiate disconnection even when none of applications of the UE 100 is using the essential DNNs. In another embodiment, during provisioning the configured-NSSAI list or the default configured-NSSAI list to the UE 100, the serving PLMN or home PLMN may additionally indicate if the UE 100 should connect to one or more DNNs, and if it should remain connected to the one or more DNNs all the time. In another embodiment, when network sends Registration Accept message to the UE 100, it may include a list of essential DNNs to which the UE 100 should remain connected all the time. Such list could be per S-NSSAI in allowed-NSSAI, or a separate list. A list of such one or more essential DNNs may be included as a part of the new IE or existing IE and may be transmitted as an existing or new messages. The messages may include one of an Access stratum (AS) message or a Non-Access Stratum (NAS) message.

In another embodiment, during provisioning URSP rules into the UE 100, the network may include an indication, for cach DNN, if the UE 100 should remain connected to that DNN all the time. In this manner, the UE 100 may initiate PDU Session Establishment Requests to all essential DNNs, and may never disconnect from any essential DNN, even if no application is using the data-path provided by the DNN. In an embodiment, the UE 100 may transmit a new or an existing message to the network indicating if the UE wants to remain connected to one or more DNN all the time. Further, the network, based on subscription verification, may never initiate disconnection to the essential DNNs.

In another example, UE's subscription in Unified Data Management (UDM) may contain additional information indicating if the UE 100 needs to remain registered to one or more S-NSSAIs and/or one or more DNNs all the time. The UDM may provide this information to an AMF (e.g., the AMF entity 200), an SMF entity (e.g., the SMF entity 300) or other responsible Network Functions (NF), when subscription information is retrieved by the corresponding Network Function, (e.g. the AMF entity 200). In an embodiment, the AMF entity 200 may provide such information to the UE 100 as part of a registration accept message, using UE configuration update procedure, UE parameter update procedure, or using a new procedure.

In an embodiment, a Home PLMN or Visited PLMN (e.g., the network apparatus 600 of the home PLMN or the visited PLMN) may determine whether the UE 100 should remain in an always-registered mode or an on-demand mode. The PLMN may configure one of the aforesaid modes in the UE 100. In the always-registered mode, the UE 100 may request for a network slice by including certain S-NSSAIs in the requested-NSSAI IE, or initiate establishment of the PDU session, even though the UE 100 is unable to determine whether at least one of the applications of the UE 100 may start using the established slice or PDU session to transmit or receive the user data.

In the on-demand mode, the UE 100 may request for the network slice by including in the requested-NSSAI IE or initiate establishment of the PDU session only when the UE 100 is sure if one or more applications of the UE 100 require the network resources such as network slices or data networks. The always-registered mode or the on-demand mode may be configured for slicing alone, PDU session alone or for both. Configuration of the always-registered mode or the on-demand mode may be pre-configured in the UE 100 (either in a mobile equipment (ME) or an UMTS subscriber identity module (USIM)) or configured by the home PLMN (H-PLMN) or the visited PLMN (V-PLMN), as part of a NAS (non-access stratum) or an AS (access stratum) message.

Advantages of the present disclosure: the present disclosure enables the UE 100 to distinguish one or more essential S-NSSAIs from a list of S-NSSAIs present in a configured NSSAI list, so that the UE 100 can always include the one or more essential S-NSSAIs in the requested NSSAI during registration procedure. Due to this, the UE 100 can remain connected to such S-NSSAIs and not all S-NSSAIs, thus ensuring improved utilization of the network resources. Consequently, network performance is enhanced and overall 5G experience of the user is improved.

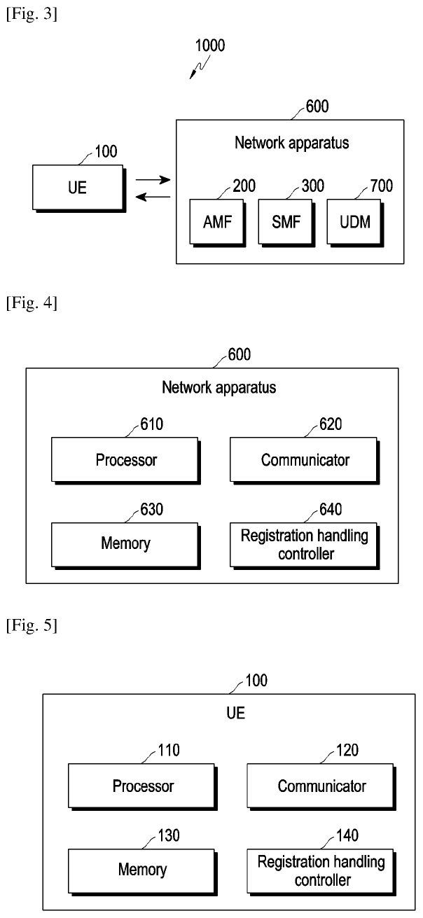

FIG. 4 illustrates various hardware components of the network apparatus 600, according to embodiments as disclosed herein. In an embodiment, the network apparatus 600 may include a processor 610, a communicator 620, a memory 630 and a registration handling controller 640. The processor 610 may be coupled with the communicator 620, the memory 630 and the registration handling controller 640. In an embodiment, the registration handling controller 640 may be implemented to be included in the processor 610.

Referring to FIG. 4, the registration handling controller 640 may determine the policy comprising the at least one of a list of S-NSSAI and a list of DNN to which the UE 100 connects to receive at least one service provided by the network apparatus 600. Further, the registration handling controller 640 may transmit the at least one policy to the UE 100 for providing the at least one service.

In an embodiment, the policy may be transmitted to the UE 100 over a message. The message can be, for example, but not limited to the registration accept message, the UE configuration update message and a NAS message. In an embodiment, the policy transmitted to the UE 100 may comprise the list of S-NSSAIs, wherein, for cach S-NSSAI in the list of S-NSSAIs, an indication is provided to indicate if the UE 100 needs to attempt to connect to that the S-NSSAI at every opportunity by sending a requested-NSSAI during a registration procedure.

In another embodiment, the at least one policy transmitted to the UE 100 comprises the list of S-NSSAIs, where the list of S-NSSAIs is taken from a Configured-NSSAI. In another embodiment, the Configured-NSSAI and an Allowed-NSSAI information clement (IE) may be extended to indicate, for each constituent S-NSSAI, whether the UE 100 needs to attempt to connect to that S-NSSAI at every opportunity/all time/all instances.

In another embodiment, the network apparatus 600 may transmit a default configured-NSSAI IE, wherein the default configured-NSSAI IE is extended to indicate, for each constituent S-NSSAI, whether the UE 100 needs to attempt to connect to that S-NSSAI at every opportunity/all time/all instances.

In another embodiment, the at least one policy transmitted to the UE 100 may include a list of DNNs, wherein for each DNN in the list of DNNs, an indication is provided to indicate if the UE 100 needs to attempt to establish connectivity to that DNN at every opportunity. In another embodiment, a UE Route Selection Policy (URSP) information may be extended to indicate, for cach DNN in the URSP, if the UE 100 needs to attempt to establish connectivity to that DNN at every opportunity/all time/all instances.

The registration handling controller 640 may determine at least one operating mode of the UE 100 to remain connected to resource of the network apparatus 600 to avail an uninterrupted service among the at least one service from the network apparatus 600, where the operating mode comprises at least one of an always-registered mode and an on-demand mode. Further, the registration handling controller 640 may transmit the operating mode to the UE 100 using at-least one of a registration-accept, a UE configuration update and a NAS message.

In an embodiment, for the always-registered mode, the UE 100 may requests for a network slice by comprising a required S-NSSAI in a requested-NSSAI IE, even if the UE 100 is unable to determine whether at least one of application running in the UE 100 requires use of a required S-NSSAI. In another embodiment, for the always-registered mode, the UE 100 may initiate establishment of a protocol data unit (PDU) session to a DNN, even if the UE 100 is unable to determine whether at least one of application running in the UE 100 requires an established PDU session to that DNN to transmit or receive a user data.

In an embodiment, for the on-demand mode, the UE 100 may request for a network slice by including in a requested-NSSAI IE or initiate an establishment of a PDU session to a DNN when the UE 100 confirms if at least one of the application running in the UE 100 requires services of the corresponding S-NSSAI or DNN.

The registration handling controller 640 may receive at least one of a list of required S-NSSAIs and a required DNN from the UE 100 during at least one of a network registration procedure and a PDU session establishment procedure. In an embodiment, the registration handling controller 640 may transmit the policy to indicate the UE 100 to attempt to remain registered all the time to the required S-NSSAI and other essential S-NSSAIs and the required DNN and other essential DNNs. In another embodiment, the registration handling controller 640 may transmit the policy to indicate the UE 100 to attempt to remain registered all the time to all the S-NSSAIs including the essential S-NSSAIs and all the DNNs including essential DNNs.

The registration handling controller 640 may determine that the UE 100 has not included at least one essential S-NSSAIs in a requested-NSSAI Information Element (IE) during a registration request, when a subscription information of the UE 100 indicates that the UE 100 needs to remain registered to the at least one essential S-NSSAIs all the time. The registration handling controller 640 may determine current availability of the at least one essential S-NSSAIs. The registration handling controller 640 may determine whether the at least one essential S-NSSAIs is allowed to be used in a current registration area of the UE 100 upon determining the availability of the at least one essential S-NSSAIs. The registration handling controller 640 may transmit a registration accept message including a new IE indicating availability of additional essential S-NSSAIs upon determining that the at least one essential S-NSSAIs is allowed in the current registration area.

The registration handling controller 640 may indicate a registration accept message whether the UE 100 attempts to remain connected to the S-NSSAI(s) all the time. Further, the registration handling controller 640 may indicate the PDU session establishment response message, whether the UE 100 attempts to remain connected to the DNN all the time.

The registration handling controller 640 may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The processor 610 may be configured to execute instructions stored in the memory 630 and to perform various processes. The communicator 620 may be configured for communicating internally between internal hardware components and with external devices via one or more networks. The memory 630 may also store instructions to be executed by the processor 610 and/or the registration handling controller 640. The memory 630 may include non-volatile storage elements. Examples of such non-volatile storage elements may include magnetic hard discs, optical discs, floppy discs, flash memories, or forms of electrically programmable memories (EPROM) or electrically crasable and programmable (EEPROM) memories. In addition, the memory (630) may, in some examples, be considered a non-transitory storage medium. The term “non-transitory” may indicate that the storage medium is not embodied in a carrier wave or a propagated signal. However, the term “non-transitory” should not be interpreted that the memory (630) is non-movable. In certain examples, a non-transitory storage medium may store data that can, over time, change (e.g., in Random Access Memory (RAM) or cache).

Further, at least one of the pluralities of modules/controller may be implemented through the AI model using a data driven controller (not shown). The data driven controller can be a ML model based controller and AI model based controller. A function associated with the AI model may be performed through the non-volatile memory, the volatile memory, and the processor 610. The processor 610 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 4 shows various hardware components of the network apparatus 600 but it is to be understood that other embodiments are not limited thereon. In other embodiments, the network apparatus 600 may include less or more number of components. Further, the labels or names of the components are used only for illustrative purpose and does not limit the scope of the invention. One or more components can be combined together to perform same or substantially similar function in the network apparatus 600.

FIG. 5 illustrates various hardware components of the UE 100, according to embodiments as disclosed herein. In an embodiment, the UE 100 may include a processor 110, a communicator 120, a memory 130 and a registration handling controller 140. The processor 110 may be coupled with the communicator 120, the memory 130 and the registration handling controller 140. In an embodiment, the registration handling controller 140 may be implemented to be included in the processor 110.

Referring to FIG. 5, the registration handling controller 140 may receive the policy comprising the list of S-NSSAI and the list of DNN from the network apparatus 600 over a message. The registration handling controller 140 may indicate the at least one S-NSSAI from the list of S-NSSAIs and the at least one DNN from the list of DNN to the network apparatus 600 for accessing the service during the network registration procedure and the PDU session establishment procedure.

The registration handling controller 140 may determine the operating mode of the UE 100 to remain connected to resource of the network apparatus 600 to avail an uninterrupted service among the at least one service from the network apparatus 600.

The registration handling controller 140 may determine the policy to indicate the UE 100 to attempt to remain registered all the time to the required S-NSSAI and other essential S-NSSAIs and the required DNN and other essential DNN based on the indication. Further, the registration handling controller 140 may transmit the policy to indicate the UE 100 to attempt to remain registered all the time to the all the S-NSSAI including the required S-NSSAI and all the DNN including essential DNN.

The registration handling controller 140 may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The processor 110 may be configured to execute instructions stored in the memory 130 and to perform various processes. The communicator 120 may be configured for communicating internally between internal hardware components and with external devices via one or more networks. The memory 130 may also store instructions to be executed by the processor 110 and/or the registration handling controller 140. The memory 130 may include non-volatile storage elements. Examples of such non-volatile storage elements may include magnetic hard discs, optical discs, floppy discs, flash memories, or forms of electrically programmable memories (EPROM) or electrically crasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Further, at least one of the pluralities of modules/controller may be implemented through the AI model using a data driven controller (not shown). The data driven controller can be a ML model based controller and AI model based controller. A function associated with the AI model may be performed through the non-volatile memory, the volatile memory, and the processor 110. The processor 110 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 5 shows various hardware components of the UE (100) but it is to be understood that other embodiments are not limited thercon. In other embodiments, the UE (100) may include less or more number of components. Further, the labels or names of the components are used only for illustrative purpose and does not limit the scope of the invention. One or more components can be combined together to perform same or substantially similar function in the UE (100).

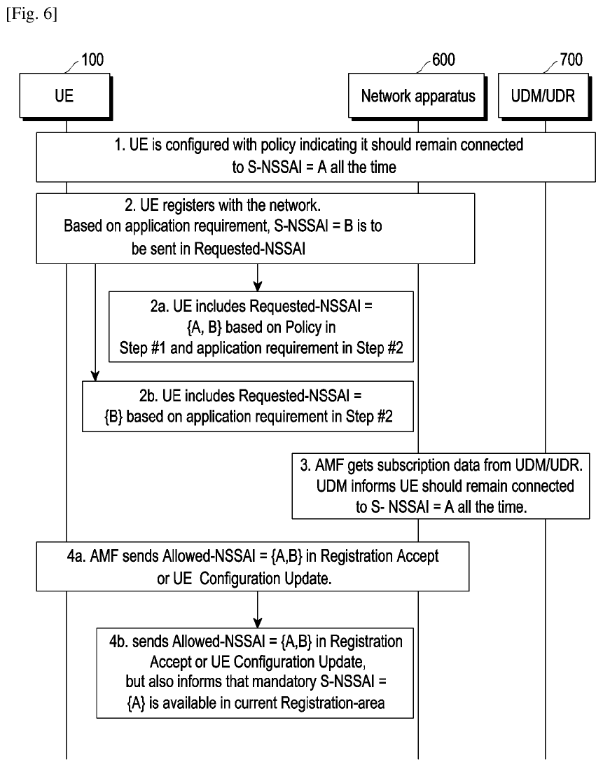

FIG. 6 illustrates exemplary representation in which the UE 100 selects the S-NSSAIs in the requested-NSSAI IE based on the application requirement, according to embodiments as disclosed herein.

Referring to FIG. 6, at step 1, the UE 100 may be configured with the policy indicating the UE 100 should remain connected to S-NSSAI=A all the time. At step 2, the UE 100 may register with the network apparatus 600. Based on the application requirement, S-NSSAI=B is to be sent in the requested-NSSAI. At step 2a, the UE 100 may include Requested-NSSAI={A, B} based on policy in step 1 and application requirement in the step 2.

At step 2b, the UE 100 may include the requested-NSSAI={B} based on application requirement in the step 2. At step 3, the network apparatus 600 (e.g., the AMF entity 200) may get subscription data from the UDM entity 700 (in another embodiment, an unified data repository (UDR)). The UDM entity 700 may inform the UE 100 should remain connected to S-NSSAI=A all the time. At step 4a, the AMF entity 200 may send the allowed-NSSAI={A,B} in the registration accept or the UE configuration update. At step 4b, the UE 100 may send Allowed-NSSAI={ A,B} in the registration accept or the UE configuration update, but also informs that mandatory S-NSSAI={A} is available in the current registration-area.

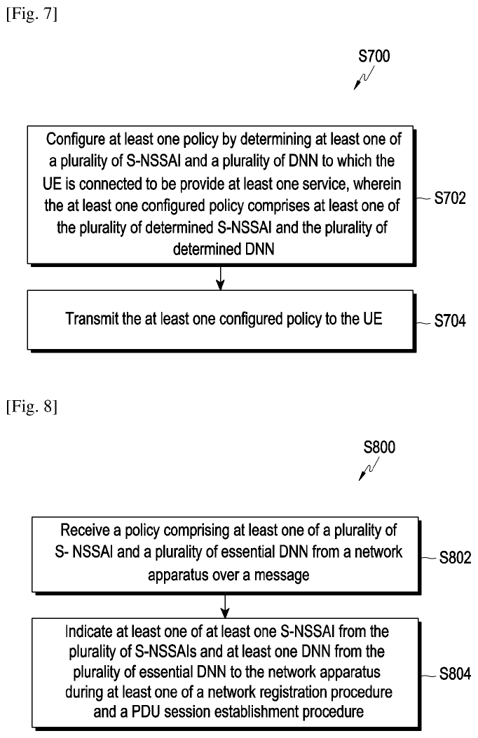

FIG. 7 shows a flow chartS700 illustrating a method, implemented by the network apparatus 600, for optimizing registration of the UE 100 to the network slice and the network apparatus 600, according to embodiments as disclosed herein. The operations S702 and S704 may be performed by the registration handling controller 640.

Referring to FIG. 7, at S702, the method may include determining the policy (e.g., the USRP) comprising the list of S-NSSAI and a list of DNN to which the UE 100 connects to receive the service provided by the network apparatus 600. At S704, the method may include transmitting the policy to the UE 100 for providing the service.

FIG. 8 shows a flow chart S800 illustrating a method, implemented by the UE 100, for optimizing registration of the UE 100 to the network slice and the network apparatus 600, according to embodiments as disclosed herein. The operations S802 and S804 may be performed by the registration handling controller 140.

Referring to FIG. 8, at S802, the method may include receiving the policy comprising the list of S-NSSAI and a list of DNN from the network apparatus 600 over the message. At S804, the method may include indicating the at least one of at least one S-NSSAI from the list of S-NSSAIs and at least one DNN from the list of DNN to the network apparatus 600 for accessing at least one service during at least one of a network registration procedure and a PDU session establishment procedure.

The present method can be used to enable the UE 100 to distinguish one or more essential S-NSSAIs from a list of S-NSSAIs present in a configured NSSAI list, so that the UE 100 can always include the one or more essential S-NSSAIs in the requested NSSAI during registration procedure. Due to this, the UE 100 remains connected to such S-NSSAIs while ensuring improves utilization of the network resources. Consequently, network performance is enhanced and overall 5G experience of the user is improved.

The various actions, acts, blocks, steps, or the like in the flow charts S700 and S800 may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

1. A method for handling registration of a user equipment (UE), the method comprising:
determining, by a network apparatus, a list of configured network slice selection information (NSSAI) to which the UE connects to receive at least one service, and an indication for each single NSSAI(S-NSSAI) in the list of configured NSSAI to indicate whether the UE needs to attempt to connect to that S-NSSAI upon receiving the list of configured NSSAI; and
transmitting, by the network apparatus, a message including the list of configured NSSAI and the indication to the UE.

2. The method as claimed in claim 1, wherein the message comprises at least one of a registration accept message, a UE configuration update message or a Non-access stratum (NAS) message.

3. The method as claimed in claim 1, wherein the indication indicates that the UE needs to attempt to connect to that S-NSSAI at every opportunity by sending a requested NSSAI during a registration procedure.

4. The method as claimed in claim 1, wherein the message comprises a list of data network names (DNNs) and an indication for each DNN in the list of DNNs, to indicate whether the UE needs to attempt to establish connectivity to that DNN at every opportunity, and wherein UE Route Selection Policy (URSP) information is extended to indicate, for each DNN in the URSP, whether the UE needs to attempt to establish connectivity to that DNN at every opportunity.

5. The method as claimed in claim 1, the method comprises:
determining, by the network apparatus, at least one operating mode of the UE to remain connected to resource of the network apparatus to avail an uninterrupted service among the at least one service from the network apparatus, wherein the operating mode comprises at least one of an always-registered mode and an on-demand mode, and
transmitting, by the network apparatus, the operating mode to the UE using at-least one of a registration-accept, a UE configuration update and a NAS message,
wherein for the always-registered mode, the UE requests for a network slice by comprising a required S-NSSAI in a requested-NSSAI IE, even if the UE is unable to determine whether at least one of application running in the UE requires use of a required S-NSSAI,
wherein for the always-registered mode, the UE initiates establishment of a protocol data unit (PDU) session to a DNN, even if the UE is unable to determine whether at least one of application running in the UE requires an established PDU session to that DNN to transmit or receive a user data, and
wherein for the on-demand mode, the UE requests for a network slice by including in a requested-NSSAI IE or initiates an establishment of a PDU session to a DNN in response to the UE confirming that at least one of the application running in the UE requires services of the corresponding S-NSSAI or DNN.

6. The method as claimed in claim 1, the method comprises
receiving, by the network apparatus, at least one of a list of required NSSAIs and a list of required data network names (DNNs) from the UE during at least one of a network registration procedure and a PDU session establishment procedure;
performing, by the network apparatus, at least one of:
determining a policy to indicate the UE to attempt to remain registered all the time to the required S-NSSAI and other essential S-NSSAIs and the required DNN and other essential DNNs; and
determining the policy to indicate the UE to attempt to remain registered all the time to all the S-NSSAIs including the essential S-NSSAIs and all the DNNs including essential DNNs.

7. The method as claimed in claim 1, the method comprises:
determining, by the network apparatus, that the UE has not included at least one essential S-NSSAIs in a requested NSSAI Information Element (IE) during a registration request, when a subscription information of the UE indicates that the UE needs to remain registered to the at least one essential S-NSSAIs;
determining, by the network apparatus, current availability of the at least one essential S-NSSAIs;
determining, by the network apparatus, whether the at least one essential S-NSSAIs is allowed to be used in a current registration area of the UE upon determining the availability of the at least one essential S-NSSAIs, and
transmitting, by the network apparatus, a registration accept message including a IE indicating availability of additional essential S-NSSAIs upon determining that the at least one essential S-NSSAIs is allowed in the current registration area.

8. The method as claimed in claim 1, the message comprises at least one of:
a registration accept message indicating whether the UE attempts to remain connected to a specific S-NSSAI; or
a PDU session establishment response message indicating whether the UE attempts to remain connected to a specific DNN.

9. A method for handling registration of a user equipment (UE), the method comprising:
receiving, by the UE from a network apparatus, a message comprising a list of configured network slice selection information (NSSAI) and an indication for each single NSSAI(S-NSSAI) in the list of configured NSSAI to indicate whether the UE needs to attempt to connect to that S-NSSAI upon receiving the list of configured NSSAI; and
identifying, by the UE (100), at least one S-NSSAI from the list of configured NSSAI to accessing for at least one service during a network registration procedure.

10. The method as claimed in claim 9, wherein for an always-registered mode, the UE requests for a network slice by comprising required S-NSSAIs in a requested-NSSAI IE, even the UE is unable to determine whether at least one application running in the UE requires use of a registered network slice.

11. The method as claimed in claim 9, wherein for an always-registered mode, the UE initiates an establishment of a PDU session, even the UE is unable to determine whether at least one application running in the UE requires an established PDU session to transmit or receive a user data.

12. The method as claimed in claim 9, wherein for an on-demand mode, the UE requests for the network slice by including in a requested-NSSAI IE or initiates establishment of the PDU session when the UE (100) confirms if at least one application running in the UE (100) require network resources.

13. The method as claimed in claim 9, the method comprises at least one of:
determining a policy to indicate the UE to attempt to remain registered all the time to the required S-NSSAI and other essential S-NSSAIs and the required DNN and other essential DNN based on the indication; and
transmitting the policy to indicate the UE to attempt to remain registered all the time to the all the S-NSSAI including the required S-NSSAI and all the DNN including essential DNN.

14. A network apparatus, comprising:
a memory; and
a registration handling controller coupled with the memory, configured to:
determine a list of configured network slice selection information (NSSAI) to which an user equipment (UE) connects to receive at least one service and an indication for each single NSSAI(S-NSSAI) in the list of configured NSSAI to indicate whether the UE needs to attempt to connect to that S-NSSAI upon receiving the list of configured NSSAI; and
transmit a message including the list of configured NSSAI and the indication to the UE.

15. A user equipment (UE), comprising:
a memory; and
a registration handling controller coupled with the memory, configured to:
receive a policy comprising at least one of a list of Single Network Slice Selection Information (S-NSSAI) and a list of essential Data Network Name (DNN) from a network apparatus (600) over a message; and
indicate at least one of at least one S-NSSAI from the list of S-NSSAIs and at least one DNN from the list of essential DNN to the network apparatus (600) during at least one of a network registration procedure and a Protocol Data Unit (PDU) session establishment procedure.
